(19) United States
(12) Patent Application Publication
(10) Pub. No.: US 2024/0008388 A1
(43) Pub. Date: Jan. 11, 2024

(54) A METHOD FOR FORECASTING OF A PARAMETER OF A CULTIVATION AREA

(71) Applicant: BASF AGRO TRADEMARKS GMBH, Ludwigshafen am Rhein (DE)

(72) Inventors: Holger HOFFMANN, Köln (DE); Ahmed Karim DHAOUADI, Koeln (DE); Manuel NOLTE, Köln (DE); Diego Armando MORALES CEPEDA, Köln (DE); Zhisheng QIN, Durham (US); Cho Miltin MBOH, Juelich (DE)

(21) Appl. No.: 18/028,392

(22) PCT Filed: Oct. 8, 2021
(86) PCT No.: PCT/EP2021/077956

§ 371 Date: Mar. 24, 2023

(30) Foreign Application Priority Data
Oct. 8, 2020 (EP) 20200831.4

(51) Int. Cl. A01B 79/00; G06N 20/20; G06Q 50/02

(52) U.S. Cl. CPC A01B 79/005; G06N 20/20; G06Q 50/02

(57) ABSTRACT

The present invention relates to a method for forecasting of a parameter value of a cultivation area, the method comprising: generating (S1), by an ensemble modelling structure, at least one first-model output parameter related to the cultivation area using ensemble modelling based on at least one first-model input parameter; generating (S2), by an machine learning structure, at least one second-model output parameter related to the cultivation area using machine learning based on at least one second-model input parameter; and merging (S3), by a model merging structure, the at least one first-model output parameter and the at least one first-model output parameter to calculate the parameter value of the cultivation area.

### FIELD OF INVENTION

The present invention relates to a method and a system for forecasting of a parameter value of a cultivation area.

### BACKGROUND OF THE INVENTION

The general background of this disclosure is the treatment of plants in a cultivation area, which may be an agricultural field, a greenhouse, or the like. The treatment of plants, such as the actual crops or the like, may also comprise the treatment of weed present in the cultivation area, the treatment of the insects in the present in the cultivation area as well as the treatment of pathogens present in the cultivation area. In this respect, it is an important aspect in the decision making process/treatment process to have a forecast of specific parameter values of the cultivation area at hand, e.g. for assessing the consumption/need of specific products like, fertilizers, crop protection products, etc. Such forecasts may also be important for controlling agricultural devices/equipment, e.g. in a semi-automated or fully automated plant treatment system. Such a semi-automated or fully automated plant treatment device, such as a robot, a smart sprayer, or the like, may be configured to treat the weed, the insects and/or the pathogens in the cultivation area. In order to automatically detect and identify the different objects to be treated, image analysis techniques, such as image recognition, may be used. For this purpose, the plant treatment device may carry an image capture device, such as a camera or the like. Further, for the actual plant treatment during operation, the plant treatment device may carry plant treatment means, such as spray nozzle, a tank, control means, etc. Typical control mechanisms for spot spraying on the cultivation area or the field are controlled based on an averaging of weeds and comparing thresholds of weed coverage to decide on spray nozzle or valve on/off.

In view of this it is been found that a further need exists to provide an improved method for forecasting of a parameter value of a cultivation area, wherein such forecasted parameter value of a cultivation area may preferably be used in semi-automated of fully automated plant treatment environment/system, e.g. as basis for controlling an agricultural equipment.

Thus, it is an object of the present invention to provide an improved method for forecasting of a parameter value of a cultivation area, wherein such forecasted parameter value of a cultivation area may preferably be used in semi-automated of fully automated plant treatment environment/system, e.g. as basis for controlling an agricultural equipment.

These and other objects, which become apparent upon reading the following description, are solved by the subject matter of the independent claims. The dependent claims refer to preferred embodiments of the invention.

### SUMMARY OF THE INVENTION

In a first aspect, there is provided a method for forecasting of a parameter or a parameter value of a cultivation area, the method comprising at least the following steps.

As a first step of the method generating, by an ensemble modelling structure, at least one first-model output parameter related to the cultivation area using ensemble modelling based on at least one first-model input parameter is performed.

As a second step of the method, generating, by a machine learning structure, at least one second-model output parameter related to the cultivation area using machine learning based on at least one second-model input parameter is performed.

As a third step of the method, merging, by a model merging structure, the at least one first-model output parameter and the at least one second-model output parameter to calculate the parameter of the cultivation area is performed.

In this way, the present disclosure provides an improved method for forecasting of a parameter value of a cultivation area by using/applying a combination of an ensemble modelling and a machine learning. Such a solution may also be used for real time cropping practices decision making, real time meaning decision making, since in practice such a solution can be processed in a very short time, for instance in milliseconds less than a few seconds after receiving the input data.

An ensemble modelling according to the present disclosure may refer to modelling time series of select crop or environmental variables with model ensembles and ensemble modelling techniques.

The term “model ensembles” according to the present disclosure may refer to a set of multiple models differing in their nature, e.g. empirical, process-based, physical, machine-learning, stochastic, etc., representation of processes, temporal and/or spatial resolution, considered types of inputs, calculation methods or other relevant parts of their structure. These model ensembles can be used to assess, cover and compensate for the uncertainty within the model's nature, e.g. empirical, process-based, physical, machine-learning, stochastic, etc., representation of processes, temporal and/or spatial resolution, considered types of inputs, calculation methods or other relevant parts of their structure.

The term “ensemble modelling techniques” according to the present disclosure may refer to a range of methods in using model ensembles. These may include using model ensembles in combination with: (i) various parametrizations and/or initializations, (ii) various, e.g. disturbed, input time series to drive the model, and/or (iii) model/model ensemble concatenation. These techniques may be applied to assess model uncertainty and to ensure, that uncertainty in initial parameters could be covered. For instance: 1) initial parameter values may be set to an array of values within a meaningful range to generate model runs in order to assess and cover the variability due to the unknown true value of the initial parameter value. 2) various, e.g. disturbed, input time series may be used to assess and cover the variability of the input time series most likely comprising the true evolution of the variable of interest, e.g. potential weather projections, varying weather data products, and/or 3) model and model ensemble concatenation can be used to assess the impact of model and data properties/uncertainty on the variable of interest (cf. e.g. “Future bloom and blossom frost risk for Malus domestica considering climate model and impact model uncertainties” or “Meteorologically consistent bias correction of climate time series for agricultural models”; Holger Hoffmann/Thomas Rath).

The term “machine-learning algorithm” is to be understood broadly and preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

In a more concrete example, ensemble modelling may comprise:
1) various time series of weather projection scenarios
2) crop yield model ensemble
3) assumptions about various environmental variable values (e.g. soil moisture status at model initialization) to initialize the model
4) assumptions about model parameters values
   wherein the crop yield models (2) are initialized with parameter settings (3) and driven by input data (1), using (4). This procedure may generate simulated time series for the past and/or future (i.e. projections). Hereby, each model ensemble member of (2) is run with initial parameter settings (3) and driven by input data (1), using (4), resulting in multiple projections for each model. During this process, each single model projection can be weighted with the support of remote sensing or ground truth crop/field/other environmental data observations (Tewes et al. 2020a, 2020b, 2020c) in order to identify more likely projections.

The model ensemble may comprise (1) process-based/empirical and (2) machine-learning data-driven models, wherein the model ensemble may most preferably comprise (1) process-based/empirical models only, i.e. without machine-learning data-driven models. Combining both model types may in particular provide the following advantages:
such an approach allows to benchmark machine-learning models compared to process-based models;
such an approach allows to identify better model candidates of process-based models to train machine learning models for situations of low data availability; and
such an approach allows to train models to predict variability, e.g. yield variability, based on the ensemble variability.

The process-based/empirical models may be calibrated and the machine-learning data-driven models may be trained prior to usage with field observations comprising, not necessarily and among other:
crop,
variety,
sowing date,
harvest date,
observed growth stages,
soil,
weather,
biomass/leaf area observations,
yield,
crop management information (e.g. irrigation and/or fertilization), and/or
crop health information (e.g. diseases).

These models are then run to predict, for example yield, using the following inputs, not necessarily and among other:
crop,
variety,
sowing date,
soil,
weather,
biomass/leaf area observations,
crop management information (e.g. irrigation and/or fertilization), and/or
crop health information (e.g. diseases).

The process-based models can then outputting continuously (e.g. daily) the following variables, not necessarily and among other:
biomass of given crop organs/leaf area,
crop growth stages,
yield, and/or
crop stress indices with regard to nutrient and water uptake as compared to nutrient and water demand

The machine-learning models may in turn outputting continuously (e.g. daily) the following variables, not necessarily and among other:
yield, and/or
other variables for which the model is trained for.

The model results from the various ensemble members and ensemble modelling techniques can be used/merged as follows:
multiple projections of both single process-based or single machine-learning models, based on same input (e.g. driving weather data, sowing date), are weighted with the support of remote sensing or ground truth crop/field/other environmental data observations (Tewes et al. 2020a, 2020b, 2020c) in order to identify more likely projections of the given single model. These runs are used to continue to project the future, and/or
machine learning models trained on upper and lower yields achieved under the given conditions are used to identify and remove outliers (e.g. less likely projected yields)

This process allows for a combined process-based and machine-learning ensemble, adjusted for upper and lower yields most likely achieved under the given conditions.

According to an embodiment of the present disclosure, the parameter is a yield of a plant grown on the cultivation area, a fertilizer forecast for the cultivation area, a biomass estimation for the cultivation area, a crop protection forecast for the cultivation area or a crop land value estimation of the cultivation area, or a nutrition demand for the cultivation area. The term “yield” is the harvested plant or crop biomass (e.g. indicated in tons or kilograms) per area unit (e.g. indicated in hectare or square meters) and per vegetation period (e.g. season), and yield is indicated for example as tons per hectare or kilograms per hectare. Notably, the term “yield” in the present disclosure can mean both, the so called “biological yield” and the so called “economic yield”. The “biological yield” is defined as “the total plant mass, including roots (biomass), produced per unit area and per growing season”. For the “economic yield”, “only those plant organs or constituents” are taken into account “around which the plant is grown”, wherein “a high biological yield is the basis for a high economic yield” (see Hans Mohr, Peter Schopfer, Lehrbuch der Pflanzenphysiologie, 3rd edition, Berlin/Heidelberg 1978, p. 560-561).”

According to an embodiment of the present disclosure, the step of merging the at least one first-model output parameter and the at least one second-model output parameter to calculate the parameter of the cultivation area comprises a weighted sum model.

According to an embodiment of the present disclosure, the at least one first-model input parameter is a chemical soil parameter, a physical soil parameter, a seed characteristics parameter, a cultivation parameter, a climate parameter, or a weather parameter.

According to an embodiment of the present disclosure, the at least one second-model input parameter is a chemical soil parameter, a physical soil parameter, a seed characteristics parameter, a cultivation parameter, a climate parameter, or a weather parameter.

According to an embodiment of the present disclosure, the ensemble modelling structure is implemented in a distributed computer environment or in a cloud-based system, wherein the method or at least the step of generating the at least one first-model output parameter related to the cultivation area using the ensemble modelling based on the at least one first-model input parameter is performed in the distributed computer environment or in the cloud-based system.

According to an embodiment of the present disclosure, the machine learning structure is implemented in a or the distributed computer environment or in a or the cloud-based system, wherein the method or at least the step of generating the at least one second-model output parameter related to the cultivation area using the machine learning based on the at least one second-model input parameter is performed in the distributed computer environment or in the cloud-based system.

According to an embodiment of the present disclosure, the model merging structure is implemented in a distributed computer environment or in a cloud-based system, wherein the method or at least the step of merging the at least one first-model output parameter and the at least one second-model output parameter to calculate the parameter of the cultivation area may be performed in the distributed computer environment or in the cloud-based system.

According to an embodiment of the present disclosure, the ensemble modelling structure is implemented in an embedded system, wherein the method or at least the step of generating the at least one first-model output parameter related to the cultivation area using the ensemble modelling based on the at least one first-model input parameter is performed in the embedded system.

According to an embodiment of the present disclosure, the machine learning structure is implemented in an embedded system, wherein the method or at least the step of generating the at least one second-model output parameter related to the cultivation area using the machine learning based on the at least one second-model input parameter may be performed in the embedded system.

According to an embodiment of the present disclosure, the model merging structure is implemented in an embedded system, wherein the method or at least the step of merging the at least one first-model output parameter and the at least one second-model output parameter to calculate the parameter of the cultivation area is performed in the embedded system.

According to an embodiment of the present disclosure, the step of generating the at least one second-model output parameter related to the cultivation area using the machine learning is performed using training data correlated to the at least one second-model input parameter is performed.

A second aspect of the present disclosure provides a system for forecasting of a parameter or a parameter value of a cultivation area, the system comprising: an ensemble modelling structure configured to generate at least one first-model output parameter related to the cultivation area using ensemble modelling based on at least one first-model input parameter; an machine learning structure configured to generate at least one second-model output parameter related to the cultivation area using machine learning based on at least one second-model input parameter; and a model merging structure configured to merge the at least one first-model output parameter and the at least one second-model output parameter to calculate the parameter of the cultivation area.

According to a third aspect of the present disclosure, a computer program element is provided, which when executed by a data processing unit, is configured to carry out the method according to the first aspect, and/or to control a device according to the second.

According to a fourth aspect of the present disclosure, a computer-readable medium is provided comprising the computer program element of the fifth aspect. The term “computer program element” is to be understood broadly, wherein the computer program element might be stored on a computer unit, which might also be part of an embodiment. This computing unit may be configured to perform or induce performing of the steps of the methods described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the present disclosure covers both, a computer program that right from the beginning uses the invention and computer program that by means of an update turns an existing program into a program that uses invention. Further on, the computer program element might be able to provide all necessary steps to fulfill the procedure of an exemplary embodiment of the methods as described above. According to a further exemplary embodiment of the present disclosure, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described aspects/embodiments of the present disclosure.

In a further aspect, the present disclosure refers to a method for applying an agricultural product on a cultivation area, comprising: providing a forecasting of a parameter value of a cultivation area according to method as described above; providing control data for an agricultural equipment for applying an agricultural product on the cultivation area based on the provided forecasted parameter value; applying the agricultural product onto the cultivation area.

In a further aspect, the present disclosure refers to a system for applying a product on a cultivation area, comprising: a providing unit for providing a forecasting of a parameter value of a cultivation area according to a method as described above; a controlling unit for controlling an agricultural equipment for applying an agricultural product on the cultivation area based on the provided forecasted parameter value; an agricultural vehicle and/or an application device for applying the agricultural product onto the cultivation area.

In a further aspect, the present disclosure refers to a use of an ensemble modelling structure and/or a machine learning structure in a method as described above. In a further aspect, the present disclosure refers to a use of a parameter value of a cultivation area provided according to a method as described above for providing control data for an agricultural equipment.

Advantageously, the benefits provided by any of the above aspects and examples equally apply to all other aspects and examples and vice versa.

These and other aspects of the present invention will become apparent from and elucidated with reference to the embodiments described hereinafter.

### BRIEF DESCRIPTION OF THE DRAWINGS

Exemplary embodiments will be described in the following with reference to the following drawings:

FIG. 1 shows a system for forecasting of a parameter or a parameter value of a cultivation area according to an embodiment of the present disclosure;

FIG. 2 shows a flow chart a method for forecasting of a parameter or a parameter value of a cultivation area according to an embodiment of the present disclosure;

FIG. 3 shows an illustration of an exemplary combination of process-based and machine learning models;

FIG. 4 illustrates an exemplary distributed system of a system according to the present disclosure for applying an agricultural product onto a cultivation area; and

FIG. 5 illustrates an example data exchange in a system according to the present disclosure.

### DETAILED DESCRIPTION OF EMBODIMENTS

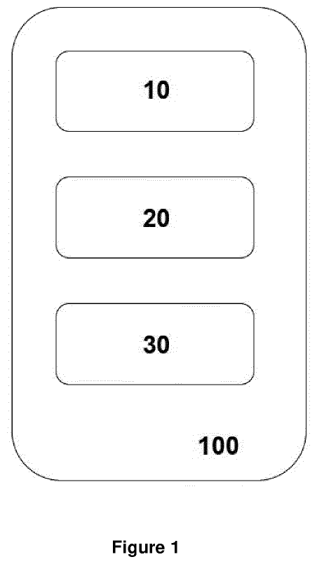

FIG. 1 shows a system for forecasting of a parameter or a parameter value of a cultivation area according to an embodiment according to an embodiment of the present disclosure.

The system 100 for forecasting of a parameter or a parameter value of a cultivation area comprises an ensemble modelling structure 10, a machine learning structure 20, and a model merging structure 30.

The ensemble modelling structure 10 is configured to generate at least one first-model output parameter related to the cultivation area using ensemble modelling based on at least one first-model input parameter.

The machine learning structure 20 is configured to generate at least one second-model output parameter related to the cultivation area using machine learning based on at least one second-model input parameter.

The model merging structure 30 is configured to merge the at least one first-model output parameter and the at least one second-model output parameter to calculate the parameter of the cultivation area.

The present disclosure advantageously allows to give output parameters recommendations/forecasts and/or control data based on such output parameters useful not only for fertilizer application, but also for fungicide, herbicide, or insecticide application, e.g. based on fertilizer recommendation control data for an agricultural equipment for applying a fertilizer may be provided.

The calculated parameter value could for instance be a variable, e.g. PRECIP, for instance the daily precipitation sum. The calculated parameter value could for instance be a variable value at a given time or point of time, e.g. PRECIP=50 mm. The calculated parameter value could for instance be a parameter (e.g. alpha) or a parameter values (e.g. alpha=1).

The calculated parameter value could for instance be a forecasting of the state of a variable of interest.

The present disclosure advantageously provides a lean decision logic, which is for example implemented preferably online (requiring for instance an internet connection on the field; can be called “cloud-based”), to have a real-time decision making.

The present disclosure advantageously provides a lean decision logic, which is for example implemented preferably as an embedded solution, which does not require an internet connection on the field, wherein software is mounted on the machine/terminal traversing the cultivation area.

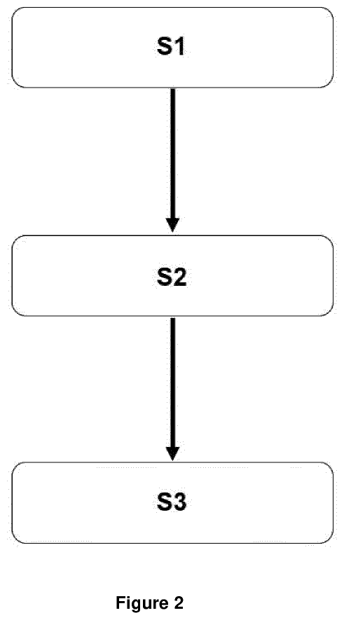

FIG. 2 shows a flow chart a method for forecasting of a parameter or a parameter value of a cultivation area according to an embodiment of the present disclosure.

A method for forecasting of a parameter or a parameter value of a cultivation area is depicted in FIG. 2, the method comprising at least the following steps.

As a first step of the method generating S1, by an ensemble modelling structure, at least one first-model output parameter related to the cultivation area using ensemble modelling based on at least one first-model input parameter is performed.

As a second step of the method, generating S2, by an machine learning structure, at least one second-model output parameter related to the cultivation area using machine learning based on at least one second-model input parameter is performed.

As a third step of the method S3, merging, by a model merging structure, the at least one first-model output parameter and the at least one second-model output parameter to calculate the parameter of the cultivation area is performed.

The present disclosure advantageously allows to use ensemble modelling for a combined output of crop model, using several crop models.

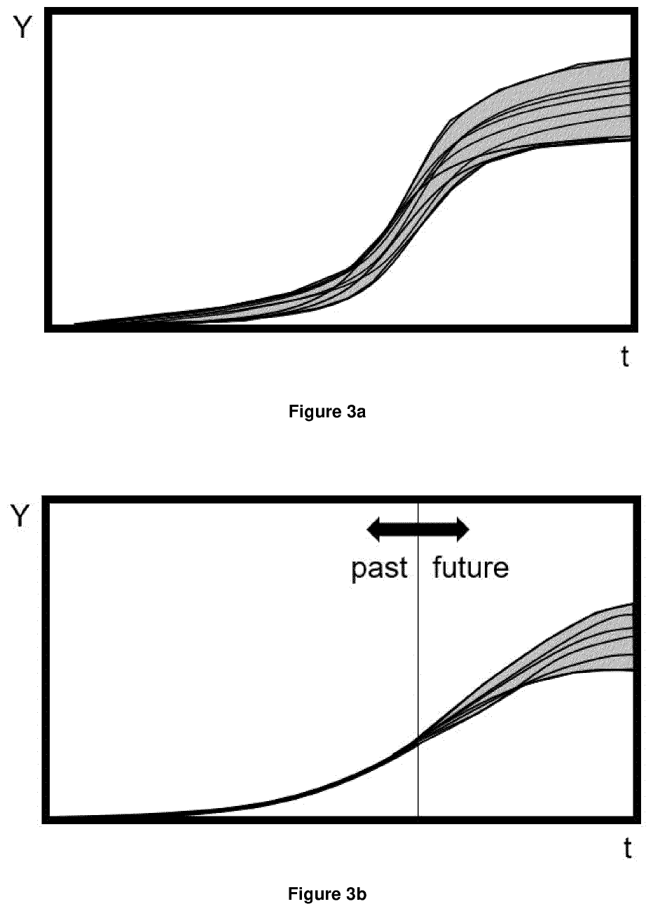

In FIG. 3 an illustration of such a combination of models, here for a yield forecast example, is shown. In this example, an ensemble of 5 process-based and 5 machine-learning models is run, each of the 10 models initialized with different settings and using multiple weather projections (cf. FIG. 3a). In this example, the machine learning models have been trained on upper and lower yields predict yields, e.g. between 7 to 10 t/ha, achieved under the given conditions. Then, model runs yielding between <7 or >10 t/ha have been removed. Given observations, “most likely runs” are identified (e.g. runs 1, 5, 27 of model 1, runs 17, 31, 67 of model 2 and so on). These runs are then used to continue to project the future as shown in FIG. 3b.

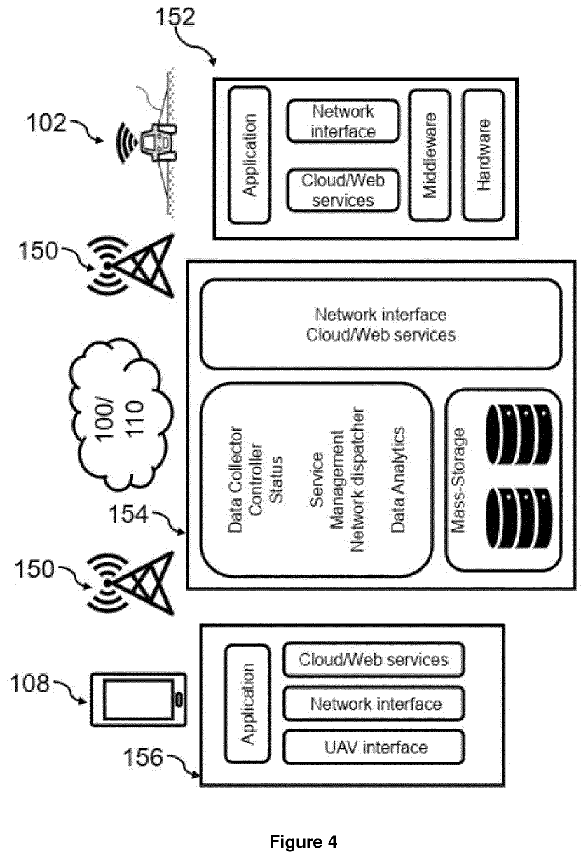

The system illustrated in FIG. 4 shows an exemplary distributed system including an agricultural vehicle 102 (e.g. a tractor for fertilizer spreading), which has been loaded/filled with an agricultural product based on a forecasting of a parameter value, e.g. a consumption of a fertilizer forecasted according to the above explained method, one or more ground station(s) 110, one or more user device(s) 108, and a cloud environment 100. The agricultural vehicle 102 may be a manned or unmanned vehicle which can be controlled autonomously by onboard computers, remotely by a person or partially remotely e.g. by way of initial operation data. The agricultural vehicle 102 may transmit data signals collected from various onboard sensors and actors mounted to the agricultural vehicle 102. Such data may include current movement data such as current speed, battery or fuel level, position, weather or wind speed, field data including treatment operation data such as treatment type, treatment location or treatment mode, monitoring operation data such as field condition data or location data, and/or operation data, such as initial operation data, updated operation data or current operation data. The agricultural vehicle 102 may directly or indirectly send data signals, such as field data or operation data, to the cloud environment 100, the ground station(s) 110 or other agricultural vehicles (not shown). The agricultural vehicle 102 may directly or indirectly receive data signals, such as field data or operation data, from cloud environment 100, the ground station(s) 110 or other agricultural vehicles.

The cloud environment 100 may facilitate data exchange with and between the agricultural vehicle(s) 102, the ground control station(s) 110, and/or user device(s) 108. The cloud environment 100 may be a server-based distributed computing environment for storing and computing data on multiple cloud servers accessible over the Internet. The cloud environment 100 may be a distributed ledger network that facilitates a distributed immutable database for transactions performed by the agricultural vehicle 102, one or more ground station(s) 110 or one or more user device(s) 108. Ledger network refers to any data communication network comprising at least two network nodes. The network nodes may be configured to a) request the inclusion of data by way of a data block and/or b) verify the requested inclusion of data to the chain and/or c) receiving chain data. In such a distributed architecture, the agricultural vehicle(s) 102, one or more ground station(s) 110, one or more user device(s) 108 can act as nodes storing transaction data in data blocks and participating in a consensus protocol to verify transactions. If the at least two network nodes are in a chain the ledger network may be referred to as a blockchain network. The ledger network 100 may be composed of a blockchain or cryptographically linked list of data blocks created by the nodes. Each data block may contain one or more transactions relating to field data or operation data. Blockchain refers to a continuously extendable set of data provided in a plurality of interconnected data blocks, wherein each data block may comprise a plurality of transaction data. The transaction data may be signed by the owner of the transaction and the interconnection may be provided by chaining using cryptographic means. Chaining is any mechanism to interconnect two data blocks with each other. For example, at least two blocks may be directly interconnected with each other in the blockchain. A hash-function encryption mechanism may be used to chain data blocks in a blockchain and/or to attach a new data block in an existing blockchain. A block may be identified by its cryptographic hash referencing the hash of the preceding block.

The agricultural vehicle 102 and the ground control station(s) 103 may share data signals with the user device(s) 108 via the cloud environment 100. Communication channels between the nodes and communication channels, between the nodes and the cloud environment 100 may be established through a wireless communication protocol. A cellular network may be established for the agricultural vehicle 102 to ground station 110, other agricultural vehicles to cloud environment 100 or ground station 110 to cloud environment 100 communication. Such cellular network may be based any known network technology such as SM, GPRS, EDGE, UMTS/HSPA, LTE technologies using standards like 2G, 3G, 4G or 5G. In a local area of an agricultural field, a wireless local area network (WLAN), e.g. Wireless Fidelity (Wi-Fi), may be established for communication. The cellular network for may be a Flying Ad Hoc Network (FANET).

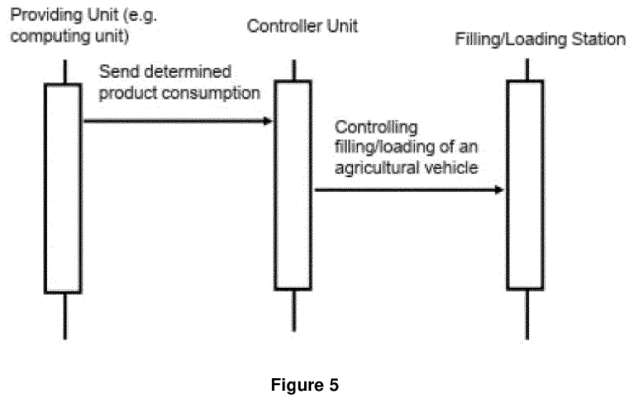

FIG. 5 illustrates one possible data flow diagram of an example for loading/filling an agricultural vehicle, e.g. a tractor for fertilizer spreading, with an agricultural product, e.g. a fertilizer. In this example, as a first data message, a forecasted fertilizer product consumption for an agricultural field/area is provided is send to a controller unit of a loading or filling station for the agricultural product, wherein this product consumption is forecasted according to a method as described above. This message can be used to control the filling/loading of the agricultural vehicle with the agricultural product according to the forecasted product consumption needed for the respective agricultural field/area.

The present disclosure advantageously provides a machine learning algorithm: Training data will be correlated to input parameters resulting in a combination of ensemble modelling and machine learning.

In another exemplary embodiment of the present disclosure, a computer program or a computer program element is provided that is characterized by being adapted to execute the method steps of the method according to one of the preceding embodiments, on an appropriate system.

The computer program element might therefore be stored on a computer unit, which might also be part of an embodiment of the present disclosure.

This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the disclosure.

This exemplary embodiment of the disclosure covers both, a computer program that right from the beginning uses the disclosure and a computer program that by means of an up-date turns an existing program into a program that uses the disclosure.

Further on, the computer program element might be able to provide all necessary steps to fulfil the procedure of an exemplary embodiment of the method as described above.

According to a further exemplary embodiment of the present disclosure, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

Although illustrative examples of the present disclosure have been described above, in part with reference to the accompanying drawings, it is to be understood that the disclosure is not limited to these examples. Variations to the disclosed examples can be understood and effected by those skilled in the art in practicing the disclosure, from a study of the drawings, the specification and the appended claims.

It has to be noted that embodiments of the present disclosure are described with reference to different subject matter. In particular, some embodiments are described with reference to method type claims whereas other embodiments are described with reference to the device type claims.

However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the present disclosure has been illustrated and described in detail in the drawings and foregoing description, such illustration and description are to be considered illustrative or exemplary and not restrictive.

The present disclosure is not limited to the disclosed embodiments. Other variations to the disclosed embodiments can be understood and effected by those skilled in the art based on the following claims, from a study of the drawings, the disclosure, and the dependent claims. In the claims, the word “comprising” does not exclude other elements or steps, and the indefinite article “a” or “an” does not exclude a plurality.

A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for forecasting of a parameter value of a cultivation area, the method comprising:
generating (S1), by an ensemble modelling structure, at least one first-model output parameter related to the cultivation area using ensemble modelling based on at least one first-model input parameter;
generating (S2), by a machine learning structure, at least one second-model output parameter related to the cultivation area using machine learning based on at least one second-model input parameter; and
merging (S3), by a model merging structure, the at least one first-model output parameter and the at least one second-model output parameter to calculate the parameter value of the cultivation area.

2. The method according to claim 1, wherein the parameter is a yield of a plant grown on the cultivation area, a fertilizer recommendation for the cultivation area, a biomass estimation for the cultivation area, a crop protection recommendation for the cultivation area or a crop land value estimation of the cultivation area, or a nutrition demand for the cultivation area, wherein in a further step controlling data for an agricultural equipment are preferably provided based on the parameter.

3. The method according to claim 1, the step of merging (S3) the at least one first-model output parameter and the at least one second-model output parameter to calculate the parameter value of the cultivation area comprises a weighted sum model.

4. The method according to claim 1, wherein the at least one first-model input parameter is a chemical soil parameter, a physical soil parameter, a seed characteristics parameter, a cultivation parameter, a climate parameter, or a weather parameter.

5. The method according to claim 1, wherein the at least one second-model input parameter is a chemical soil parameter, a physical soil parameter, a seed characteristics parameter, a cultivation parameter, a climate parameter, or a weather parameter.

6. The method according to claim 1, wherein the ensemble modelling structure is implemented in a distributed computer environment or in a cloud-based system, wherein the method or at least the step of generating (S1) the at least one first-model output parameter related to the cultivation area using the ensemble modelling based on the at least one first-model input parameter is performed in the distributed computer environment or in the cloud-based system.

7. The method according to claim 1, wherein the machine learning structure is implemented in a distributed computer environment or in a cloud-based system, wherein the method or at least the step of generating (S2) the at least one second-model output parameter related to the cultivation area using the machine learning based on the at least one second-model input parameter is performed in the distributed computer environment or in the cloud-based system.

8. The method according to claim 1, wherein the model merging structure is implemented in a distributed computer environment or in a cloud-based system, wherein the method or at least the step of merging (S3) the at least one first-model output parameter and the at least one second-model output parameter to calculate the parameter value of the cultivation area is performed in the distributed computer environment or in the cloud-based system.

9. The method according to claim 6, wherein the ensemble modelling structure is implemented in an embedded system, wherein the method or at least the step of generating (S1) the at least one first-model output parameter related to the cultivation area using the ensemble modelling based on the at least one first-model input parameter is performed in the embedded system.

10. The method according to claim 7, wherein the machine learning structure is implemented in a embedded system, wherein the method or at least the step of generating (S2) the at least one second-model output parameter related to the cultivation area using the machine learning based on the at least one second-model input parameter is performed in the embedded system.

11. The method according to claim 8, wherein the model merging structure is implemented in an embedded system, wherein the method or at least the step of merging (S3) the at least one first-model output parameter and the at least one second-model output parameter to calculate the parameter value of the cultivation area is performed in the embedded system.

12. The method according to claim 1, wherein the step of generating (S2) the at least one second-model output parameter related to the cultivation area using the machine learning is performed using training data correlated to the at least one second-model input parameter is performed.

13. A system (100) for forecasting of a parameter value of a cultivation area, the system comprising:
an ensemble modelling structure configured to generate at least one first-model output parameter related to the cultivation area using ensemble modelling based on at least one first-model input parameter;
an machine learning structure configured to generate at least one second-model output parameter related to the cultivation area using machine learning based on at least one second-model input parameter; and
a model merging structure configured to merge the at least one first-model output parameter and the at least one second-model output parameter to calculate the parameter value of the cultivation area.

14. (canceled)

15. A method for applying an agricultural product on a cultivation area, comprising:
providing a forecasting of a parameter value of a cultivation area according to the method of claim 1;
providing control data for an agricultural equipment for applying an agricultural product on the cultivation area based on the provided forecasted parameter value; and
applying the agricultural product onto the cultivation area.

16. A system for applying a product on a cultivation area, comprising:
a providing unit for providing a forecasting of a parameter value of a cultivation area according to the method of claim 1;
a controlling unit for controlling an agricultural equipment for applying an agricultural product on the cultivation area based on the provided forecasted parameter value; and
an agricultural vehicle and/or an application device for applying the agricultural product onto the cultivation area.

17. Use of an ensemble modelling structure and/or a machine learning structure in a method according to claim 1.

18. Use of a parameter value of a cultivation area provided according to claim 1.

19. A non-transitory computer-readable medium having instructions encoded thereon that, when executed by a data processing unit, cause the data processing unit to perform the method of claim 1.
